(19) United States
(12) Patent Application Publication
(10) Pub. No.: US 2012/0013583 A1
(43) Pub. Date: Jan. 19, 2012

(54) BRIGHTNESS LEVEL ADJUSTMENT OF A LIGHTED DISPLAY DEVICE

(76) Inventors: John P. Powell, Spring, TX (US); Jeffrey A. Lev, Tomball, TX (US)

(21) Appl. No.: 13/259,929

(22) PCT Filed: Dec. 11, 2009
(86) PCT No.: PCT/US09/67714

§ 371 Date: Sep. 23, 2011

(51) Int. Cl. G09G 5/00

(52) U.S. Cl. 345/207

(57) ABSTRACT

A lighted display device that includes a display device, a backlight device and an electrical delay circuit. The backlight device is disposed proximate the display device and configured to emit light directed to the display device. The ambient light sensor is configured to generate a signal to adjust a brightness level of the light from the backlight device based on a change in input ambient light. The electrical delay circuit is configured to apply a fixed, non-user configurable time delay to delay the adjustment of the brightness level of the light from the backlight.

### BACKGROUND

Computing devices such as notebook computers include a display and a backlight device configured to emit light to illuminate the display.

### BRIEF DESCRIPTION OF THE DRAWINGS

For a detailed description of exemplary embodiments of the invention, reference will now be made to the accompanying drawings in which:

FIG. 1 shows a system that includes brightness level adjustment of a lighted display device, with the display member shown in exploded view, constructed in accordance with at least some illustrative embodiments;

FIG. 2 shows a block diagram of the system of FIG. 1 having a brightness level adjustment of a lighted display device, constructed in accordance with at least some illustrative embodiments;

FIG. 3 is a flow chart showing a method of performing brightness level adjustment of a lighted display device, constructed in accordance with at least some illustrative embodiments; and

FIG. 4 are graphs showing brightness level adjustment of a lighted display device, constructed in accordance with at least some illustrative embodiments.

### DETAILED DESCRIPTION

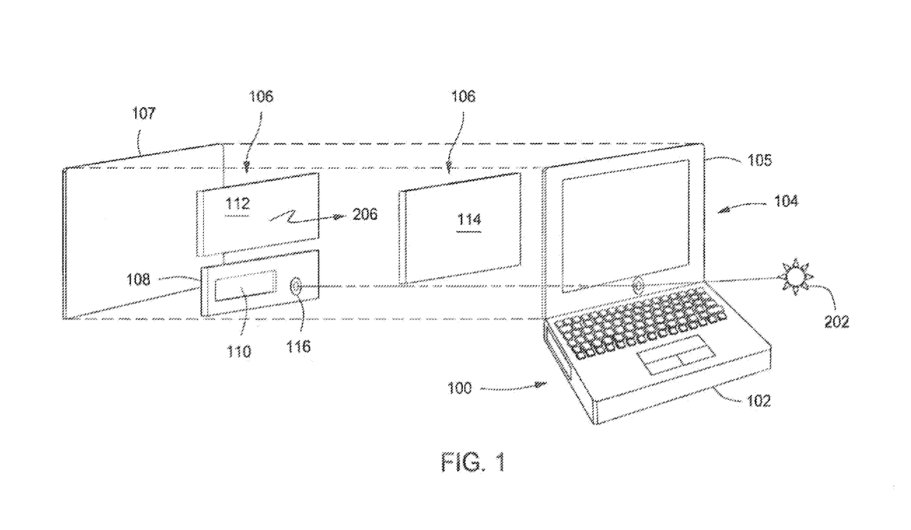

As will be explained below in further detail, in some embodiments, a time delay is applied to help smooth or delay abrupt changes to the brightness level of light emitted by the backlight device in response to abrupt changes in input ambient light, resulting in a more desirable user experience. FIG. 1 shows a system 100 that includes brightness level adjustment of a lighted display device applicable to a variety of applications in accordance with various embodiments. The system 100 includes a computing device embodied as a notebook computer having base member 102 mechanically coupled to display member 104 such that the display member can be adjusted to provide a variable viewing angle. As shown in the exploded view of the display member, the display member has a front portion 105 and a rear portion 107 which is sized and shaped to house lighted display device 106 which comprises display device 114 and backlight device 112, and ambient light sensor (ALS) circuit 108. The display device 114 is configured to provide video information. The display device 114 is disposed adjacent to backlight device 112 which is configured to emit light 206 to illuminate at least a portion of the display device. The ALS circuit 108 comprises ambient light sensor 116 and electrical delay circuit 110. In some embodiments, the ambient light sensor 116 and delay circuit 110 are disposed on the same support member such as printed circuit board. The ambient light sensor 116 is configured to receive input ambient light from external light source 202 through an opening located at the front portion 105 of the display member. The electrical delay circuit 110 receives these changes from the ambient light sensor 116 and causes the backlight device to adjust a brightness level of the light 206 from the backlight device. The delay circuit 110 is configured to apply a fixed, non-user configurable time delay to delay the adjustment of the brightness level of the light from the backlight device. In some embodiments, electrical delay circuit 110 generates a signal to delay adjustment of the brightness level having a rate of change that is less than a rate of change of the input ambient light. As will be explained below in further detail, in some embodiments of system 100, the time delay applied by delay circuit 110 helps smooth or delay abrupt changes to the brightness level of light emitted by the backlight device in response to abrupt changes in input ambient light, resulting in a more desirable user experience. The base member 102 includes a processor and memory having instructions to be executed by the processor to control the display of visual information on display device 114 as well as control other aspects of the computing device.

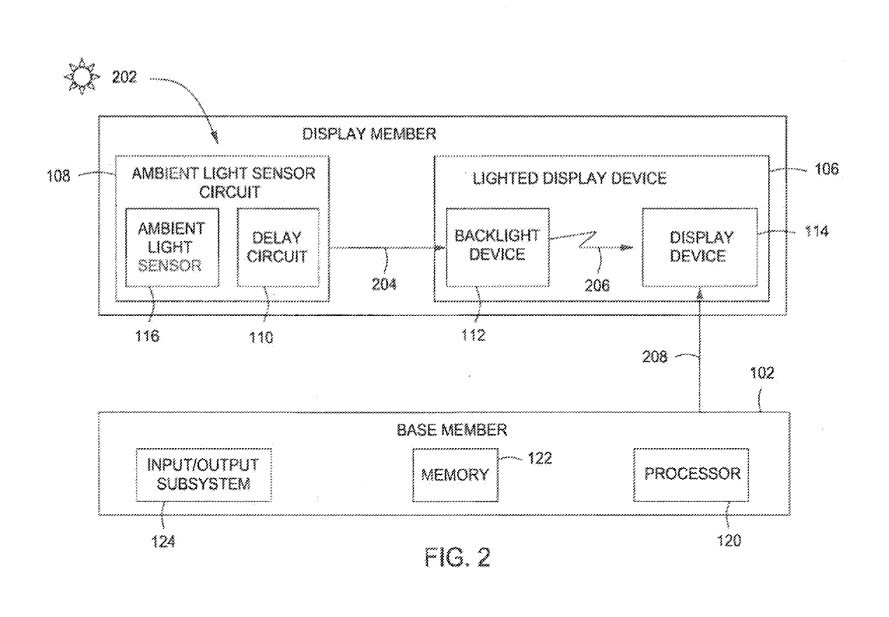

FIG. 2 shows a block diagram of the system 100 including brightness level adjustment of a lighted display device applicable to a variety of applications in accordance with various embodiments. As explained above, display member 104 includes display device 114 which is configured to provide video information such as, for example, visual images from applications or other media content. The backlight device 112 is configured to emit light 206 to illuminate at least a portion of display device 114. The ambient light sensor 116 is configured to receive and detect changes in input ambient light from external light source 202. The ambient light sensor 116 feeds these changes as a signal 204 to backlight device 112 which adjusts a brightness level of the light 206 from the backlight device. The electrical delay circuit 110 is configured to apply a fixed, non-user configurable time delay to the adjustment of the brightness level, in response to a change in input ambient light 202. The time delay is fixed, non-user configurable because it is implemented in hardware and located within the display member and with no ability for a user to access.

In some embodiments, electrical delay circuit 110 comprises a passive filter circuit configured as a resistor and capacitor component arrangement. The delay circuit 110 helps prevent abrupt changes to brightness level of light generated by the backlight device in response to abrupt changes in input ambient light. That is, if the brightness level is gradually changed over a time period, rather than changed in an abrupt manner, the user would actually discern little or no change in brightness level, even though the brightness level was changed. In some embodiments, the time delay may be a fixed time delay for a period in the range of about 20 seconds to 40 seconds. In some embodiments, the time delay can be about 30 seconds. The time period can be any other time period as long as the change in brightness level of light provided by backlight device 112 is sufficiently gradual to match how a user's eyes adjust to changes in light. In some embodiments, the brightness level has a value from a fixed, non-user configurable brightness range.

It is undesirable for brief interruptions in ambient light to reach the sensor because this may cause drastic changes in the brightness level of the light from backlight device. For example, if light was prevented from reaching the ambient light sensor for a brief moment, such as if the user momentarily moved their hand over the light sensor, the light from the backlight device would immediately decrease or dim. Conversely, if the ambient light sensor suddenly received an increase in light, such as from an external light source which was suddenly turned on, then the brightness level of the light of the backlight device would increase immediately. This may result in an unsatisfactory user experience. In some embodiments of the system, a time delay is applied to prevent abrupt changes in ambient light from reaching the display device which may result in a more satisfying user experience.

In some embodiments, the output of the ambient light sensor can be coupled to an output driver such as a pulse width modulation (PWM) function which can generate an output signal to drive backlight device. In some embodiments, the delay circuit may be coupled to the PWM function and configured to control (i.e., delay) the reaction time of the PWM and thus delay the adjustment of the brightness level of the backlight device.

As explained above, display member 104 is mechanically coupled to base member 102. In some embodiments: display member 104 can be mechanically coupled to base 102 member using coupling means as such as rotatable, hinge, or other means. In some embodiments, base member 102 can be sized and shaped to house one or more printed circuit boards to support processor 120 and memory 122. The display member 104 can be sized and shaped to house one or more printed circuit boards to support ALS circuit 108 and lighted display device 106. As explained above, in some embodiments, ambient light sensor 116 and delay circuit 110 can be disposed on the same printed circuit board. In some embodiments, display device 114 and backlight device 112 are formed as an integrated module. In some embodiments, such integrated module can include ALS circuit 108 which helps reduce cost of manufacture. Other circuitry to provide functionality for operating the computing device can be disposed on the printed circuit boards of the base member, the printed circuit boards of the display member, or a combination thereof.

In other embodiments, the system 100 can be a tablet computing device implemented as a display member 104 without a base member 102. The display member would include a touch screen device placed over the display device. The touch screen device would enable user input to the system without the need for a conventional keyboard component of the base member. In this embodiment, processor 120 and memory 122 would be disposed in the display member.

The display device 114 provides video information to a user of the system 100, and can be, for example, a liquid crystal display (“LCD”), an organic light emitting diode (“OLED”) display, or any other display technology. The delay techniques of the present application are described in the context of a transmissive display system. In this embodiment, display device 114 has no reflector to reflect light from external source 202 so it requires a backlight device.

In another embodiment, the delay techniques of the present application can be in implemented in a transflective display system. In this embodiment, display device 114 may include a reflector to reflect light from external source 202. The reflector would have holes through which light from the backlight device can pass through for darker environments.

The memory 122 includes instructions to be executed by processor 120 to control the visual display of the display device as well as control other aspects of the computing device. The processor 120 provides video information or data 208 that is presented to the user in visual form on display 114. Video information 208 can include textual data, graphical data, etc.

The processor 120 can be a general purpose microprocessor, microcontroller, digital signal processor, etc. configured to execute software programs. The components of a processor are well known in that art and generally include execution units (e.g., integer, fixed point, floating point, etc.), instruction decoding, registers, memories, input/output ports, etc, interconnected by buses. The memory 122 is coupled to processor 120. The memory 122 can include various storage media, for example, magnetic storage (e.g., hard disks, floppy disks, tape, etc.), optical storage (e.g., compact disk, digital video disk, etc.), or semiconductor memory (e.g., static or dynamic random-access-memory (“SRAM” or ° DRAM″), read-only-memory (“ROM”), FLASH memory, magnetic random access memory (“MRAM”), etc.). The system 100 includes software programming stored in memory 122 that when executed by processor 120 controls operation necessary of system 100.

Some embodiments of the system 100 can include input/output subsystem 124 which can comprise input devices, such as a keyboard, a mouse, etc. Embodiments can also include various input/output sub-systems to implement, for example, wired and/or wireless networking. In FIG. 1, the system 100 is depicted as a notebook computer, however in practice the system 100 can be any of a variety of electronic devices. For example, the system 100 can be a telephone, personal digital assistant, music player, desktop computer, laptop computer, satellite navigation system, gaming system or other device that provides a display device.

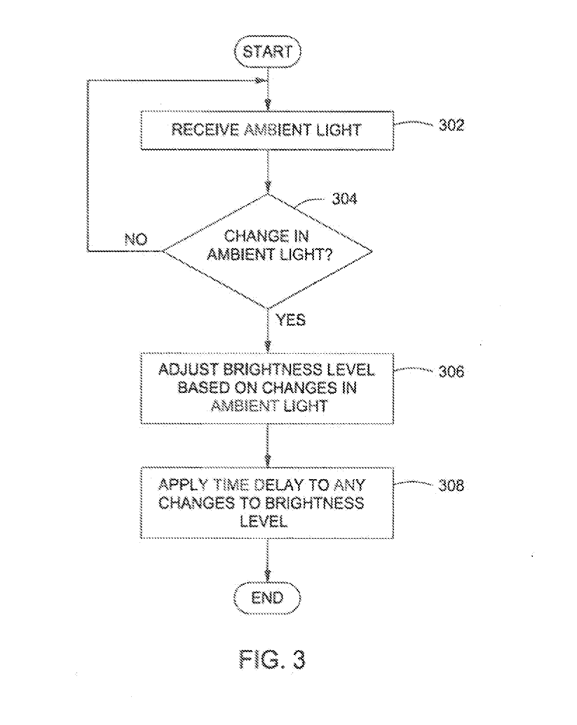

FIG. 3 shows a flow diagram for a method for implementing brightness level adjustment of a lighted display device applicable to a variety of applications in accordance with various embodiments. Though depicted sequentially as a matter of convenience, at least some of the actions shown can be performed in a different order and/or performed in parallel. Additionally, some embodiments may perform only some of the actions shown.

In block 302, ambient light sensor 116 receives ambient light 202 from an external light source such as light from a lamp disposed proximate the system 100. As explained below, ambient light sensor 116 sends a signal to delay circuit 110. The delay circuit 110 adjusts the brightness level of light from the backlight device. Independent of the adjustment of brightness level 206, base member components (processor and memory) generate video signal 208 to provide video information on display device 114.

In block 304, ambient light sensor 116 determines whether there is a change in ambient light. If there is a change in ambient light, then processing continues at block 306, otherwise processing continues in block 302. In some embodiments, a change can comprise an increase or decrease in ambient light. For example, an increase in ambient light can be caused by an increase in light from a lamp proximate system 100. Conversely, a decrease in ambient light can be caused by a decrease (dimming) in light from a lamp proximate system 100.

At block 306, ambient light sensor 116 generates a signal representing the change in ambient light to adjust the brightness level of backlight device 112, in at least some embodiments. In some embodiments, the system generates a signal representing an increase or decrease in ambient light in the form of a corresponding PWM signal. Processing continues at block 308.

At block 308, delay circuit 11C receives the signal from ambient light sensor 116 and applies a delay to the adjustment of the brightness level, in at least some embodiments. For example, in response to a sudden increase in ambient light, the delay circuit responds by adjusting the brightness level in a gradual manner so to help prevent a sudden change in brightness level due to the sudden change in ambient light. Accordingly, sudden changes in ambient light are converted into gradual changes in brightness level providing for a more satisfying user experience.

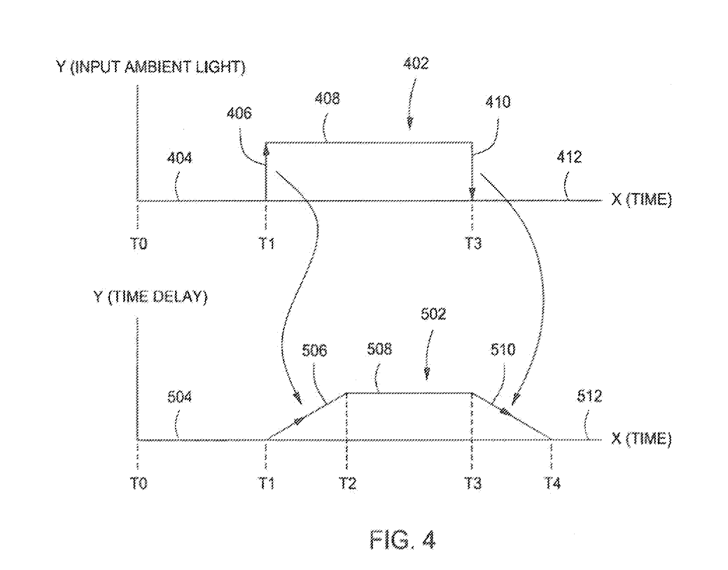

FIG. 4 are graphs showing brightness level adjustment of a lighted display device, constructed in accordance with at least some illustrative embodiments. Specifically, graph 402 shows changes in input ambient light (Y axis) over time (X axis) and graph 404 shows brightness level adjustment of light (Y axis) from the backlight device over time (X axis). To illustrate, it will be assumed that at an initial point in time, such as time T0, system 100 is in the OFF state with no power being supplied to the system. As a result, system 100 is not able to detect ambient light (depicted by 404) and accordingly backlight device 112 does not emit any light (depicted by 504).

At some future point in time, such as time T1, it will be assumed that a user places system 100 in the ON state such as by switching the power switch of the computer device to the ON position, thereby supplying power to the system. At time T1, ambient light sensor 116 is active and can detect ambient light. At this time, it will be assumed, to illustrate, that there is a sudden increase in input ambient light (depicted by 406) such as light from a lamp proximate ambient light sensor 116. The ambient light sensor 116 detects the increase in light and generates a signal representing this increase in light to delay circuit 110. The delay circuit 110 receives this signal and responds by applying a time delay (depicted by 506) so as to gradually increase the brightness level generated by the backlight device. Specifically, the brightness level increases from a low value beginning at time T1 and gradually increases to a higher value at time T2. As shown, a sudden increase in ambient light 406 does not cause a sudden increase in the brightness level of light from backlight device 112. The delay circuit 110 prevents abrupt changes to the brightness level of light from being generated by backlight device 112. As explained above, in some embodiments, the brightness level is from a fixed, non-user configurable brightness range. In some embodiments, the time delay (from time T1 to time T2) is a fixed time delay for a period of about 30 seconds.

After time T2, it will be assumed for illustrative purposes, that there is no further change in ambient light level as depicted by 408. Accordingly, the ALS circuit does not generate any change in brightness level as depicted by 508.

At some future point in time, such as time T3, for illustrative purposes, it will be assumed that there is a sudden decrease in ambient light, as depicted by 410. This may be caused by, for example, a user dimming a light from a lamp proximate system 100. In a similar manner, as described above in the case of a sudden increase in ambient light depicted by 406, ambient light sensor 116 detects this sudden decrease and delay circuit 110 applies a time delay to prevent a sudden decrease in the brightness level from being generated by the backlight device. Accordingly, the brightness level decreases from the value set at the previous level at time T3 to a lower value at time T4. Again, like the gradual increase in the brightness level of backlight device 112 described above, the gradual decrease in the brightness level helps prevent sudden changes in brightness level in response to sudden changes in ambient light. As such, sudden changes in ambient light are converted into gradual changes in brightness level thereby providing a more satisfying user experience.

After time T4, for illustrative purposes, it will be assumed that there is no further change in ambient light level as depicted by 412. Accordingly, ALS circuit 108 does not generate any change in brightness level as depicted by 512. Although the operation of the system was described in the context of a sequence comprising first an increase and then a decrease in ambient light, it should be understood that in some embodiments, the system is capable of processing changes in ambient light in any sequence and over any time period.

Some embodiments of the present application can exhibit various advantages. For example, the time delay can be implemented in hardware (electrical delay circuit) and not in software (computer program instructions). Accordingly, computing resources, such as processor processing time and memory space, can be allocated or assigned to more efficient use. Furthermore, the time delay and the brightness range can be fixed and non-user configurable which may reduce the need for user input. The reduction in user input may help decrease the possibility of erroneous brightness setting by the user, which may improve the accuracy of the brightness level. Moreover, power consumption may be reduced because the brightness level is automatically adjusted without user intervention. Because of the fixed nature of the time delay, it may no longer be necessary to allocate computer resources for developing or providing a graphical user interface for allowing a user to adjust the brightness level or select a brightness range. This may help reduce computing resources thereby helping decrease manufacturing costs.

In some embodiments, the fixed time delay of, for example, about 30 seconds may be advantageous. In one embodiment, this time delay is about 5 second time-constant in the context of a resistor capacitor arrangement. In one embodiment, this time delay may make the change in the total brightness gradual enough to not be noticeable to the user. Moreover, this time delay may help reduce the occurrence of minor interruptions in light to the sensor (e.g., a user inadvertently pressing a function key close to the sensor) which would otherwise cause an unintentional yet very noticeable change in the brightness level of the display device.

As explained above, in some embodiments, disposing ALS circuit 108 in the display member and adjacent lighted display device106 instead of the base member may provide various advantages. For example, ALS circuit 108 is disposed in close proximity to the display device which may require less wiring for electrically connecting the ALS circuit to the backlight device, thereby helping reduce manufacturing cost.

The above discussion is meant to be illustrative of the principles and various embodiments of the present invention. Numerous variations and modifications will become apparent to those skilled in the art once the above disclosure is fully appreciated. For example although the illustrative embodiments of the present disclosure are shown and described within the context of a laptop computer, other types of computer systems are also equally well suited for use with ALS circuit 108. It is intended that the following claims be interpreted to embrace all such variations and modifications.

What is claimed is:

1. A lighted display device comprising:
a display device;
a backlight device disposed proximate the display device and configured to emit light directed to at least a portion of the display device;
an ambient light sensor configured to generate a signal to adjust a brightness level of the light from the backlight device based on a change in input ambient light; and
an electrical delay circuit configured to apply a fixed, non-user configurable time delay to delay the adjustment of the brightness level of the light from the backlight device.

2. The lighted display device of claim 1, further comprising a display member coupled to a base member, the base member sized to house a processor to control the video information on the display device, and the display member sized to house the display device, the backlight device, the ambient light sensor, and the electrical delay circuit.

3. The lighted display device of claim 1, further comprising a display member sized to house the display device, the backlight device, the ambient light sensor, and the electrical delay circuit.

4. The lighted display device of claim 1, wherein the electrical delay circuit generates a signal to delay adjustment of the brightness level having a rate of change that is less than a rate of change of the input ambient light.

5. The lighted display device of claim 1, wherein a decrease in ambient light causes a decrease in the brightness level.

6. The lighted display device of claim 1, wherein a decrease in ambient light causes a decrease in the brightness level.

7. The lighted display device of claim 1, wherein the brightness level has a value from a fixed, non-user configurable brightness range.

8. The lighted display device of claim 1, wherein the lighted display device comprises a transflective display system or a transmissive display system.

9. The lighted display device of claim 1, wherein the electrical delay circuit comprises a resistor and capacitor arranged to provide a time constant.

10. A computing device comprising:
a display member sized to house:
a display device,
a backlight device disposed proximate the display device and configured to emit light directed to at least a portion of the display device,
an ambient light sensor configured to generate a signal to adjust a brightness level of the light from the backlight device based on a change in input ambient light, and
an electrical delay circuit configured to apply a fixed, non-user configurable time delay to delay the adjustment of the brightness level of the light from the backlight device; and
a base member coupled to the display member, the base member sized to house a processor configured to control the visual display of the display device.

11. The computing device of claim 10, wherein the electrical delay circuit generates a signal to delay adjustment of the brightness level having a rate of change that is less than a rate of change of the input ambient light.

12. The computing device of claim 10, wherein an increase in ambient light causes an increase in the brightness level.

13. The computing device of claim 10, wherein a decrease in ambient light causes a decrease in the brightness level.

14. The computing device of claim 10, wherein the brightness level has a value from a fixed, non-user configurable brightness range.

15. The computing device of claim 10, wherein the lighted display device comprises a transflective display system or a transmissive display system.

16. A method comprising:
emitting, by a backlight device disposed proximate a display light, light directed to at least a portion of the display device;
generating, by an ambient light sensor, a signal to adjust a brightness level of the light from the backlight device based on a change in input ambient light; and
applying, by an electrical delay circuit, a fixed, non-user configurable time delay to delay the adjustment of the brightness level of the light from the backlight device.

17. The method of claim 16, wherein the electrical delay circuit generates a signal to delay adjustment of the brightness level having a rate of change that is less than a rate of change of the input ambient light.

18. The method of claim 16, wherein an increase in ambient light causes an increase in the brightness level.

19. The method of claim 16, wherein a decrease in ambient light causes a decrease in the brightness level.

20. The method of claim 16, wherein the brightness level has a value from a fixed, non-user configurable brightness range.
